(19) United States
(12) Patent Application Publication
(10) Pub. No.: US 2009/0087765 A1
(43) Pub. Date: Apr. 2, 2009

(54) Toner for developing electrostatic latent image

(75) Inventor: Hiroto Kidokoro, Tokyo (JP)

Correspondence Address: KRATZ, QUINTOS & HANSON, LLP, 1420 K Street, N.W., Suite 400, WASHINGTON, DC, 20005, US

(73) Assignee: Zeon Corporation, Tokyo (JP)

(21) Appl. No.: 11/905,568

(22) Filed: Oct. 2, 2007

Related U.S. Application Data
(62) Division of application No. 10/549,145, filed on Sep. 15, 2005, now abandoned.

(30) Foreign Application Priority Data
Mar. 17, 2003 (JP) JP2003-071591
Mar. 17, 2003 (JP) JP2003-071592

(51) Int. Cl. G03G 9/08

(52) U.S. Cl. 430/108.1

(57) ABSTRACT

A toner for developing an electrostatic latent image, comprising a toner particles containing at least a binder resin, a colorant and a charge control agent, the toner particles having a volume mode diameter (a) from 5 to 10 μm, a ratio (Dv/Dp), of a volume average particle diameter (Dv) to a number average particle diameter (Dp), from 1.0 to 1.3, and an average circle degree from 0.97 to 0.995, the toner particles having a standard deviation (b) not more than 2 μm of the particle diameter, the toner particles having a ratio (C1/C2) from 1.00 to 1.02, wherein c1 represents an average circle degree of the toner particles having a particle diameter not less than (a−2b) μm to less than a μm, and c2 represents an average circle degree of the toner particles having a particle diameter not less than a μm and less than (a+2b) μm, wherein a water extract obtained by dispersing the toner in ion exchange water having a conductivity σ1 from 0 to 10 μS/cm so that the toner concentration is 6% by weight, heating to boil the water for 10 minutes, adding separately boiled ion exchange water having a conductivity σ1 from 0 to 10 μS/cm thereto to compensate for evaporated water up to the original volume, and cooling to a room temperature has a conductivity σ2 from 20 μS/cm or less, and σ2−σ1 is from 0.1 to 10 μS/cm.

### TECHNICAL FIELD

The present invention relates to a toner for developing an electrostatic latent image, and more specifically to a toner for developing an electrostatic latent image, less likely to cause fog and excellent in dot reproducibility and printing characteristics.

### BACKGROUND ART

Electrophotography, in general, is a process involving forming an electrostatic latent image on a photoconductive member by various methods, followed by development of the latent image to a visible image, and after transferring toner forming the visible image to a transfer member such as paper or an OHP sheet, fixing the transferred toner on the transfer member by pressure or the like, thereby obtaining printing.

Currently, printers and copying machines are becoming more and more advanced and achievement of high speed as well as high resolution by a method of forming an electrostatic latent image by a laser is demanded. Accordingly, in addition to achieving small particle diameters and sharp particle diameter distribution for responding to the high resolution requirement, toners are required to have low-temperature fixability so as to correspond with high-speed model equipment. In particular, for color toners, required levels of such properties are high because toners of four colors are interposed to form images.

In addition, stability of electrostatic properties and cleaning properties of toners are required as in conventional cases. This is because change in electrostatic properties over time has a great impact on the quality of images and because softener or parting agent added for low temperature fixing lowers shelf stability, causing problems such as blocking of toner.

Conventionally, toners have been produced by the pulverization method, namely, by melting and mixing colorant such as dye or pigment and other additives with binder resin such as thermoplastic resin and dispersing homogeneously, followed by fine pulverization by a pulverizer. In this pulverization method, it is difficult to make the particle diameter of toner about 5 to 6 μm or smaller, and there is a limit to narrowing of the particle diameter distribution by using the classification step. Further, because additives are exposed on the toner surface, control of the amount of electrostatic charge of toner is difficult, causing problems such as scattering of images and fog. As an example of toner produced by such pulverization method, Japanese Patent Application Laid-Open No. 1999-202557 discloses a toner with a controlled particle diameter, particle diameter distribution, circled degree, etc. The toner disclosed in the above document is produced by a pulverization method, and it is publication to remove fine particles or avoid generation of fine powder, and because of wide circle degree distribution, the toner had insufficient dot reproduction and the like.

Recently, to achieve small particle diameter and to make particle distribution narrow, toners produced by a polymerization method are being used. In the case of toners produced by a polymerization method, charging stability can be improved by further reducing adhering of fine particles and bleeding of additive components on the surface. The present applicant discloses a developer according to a polymerization method having a content of metal ions, derived from a hardly water-soluble metal compound, of not more than 1,000 pμm in Japanese Patent Application Laid Open No. 1996-160661. In the developer disclosed in the publication, decrease in the image quality due to environmental change has been remarkably improved, but further improvement in the flowability and the shelf stability has been required. Japanese Patent Application Laid Open No. 1999-72949 discloses a developer of a specific pH range and a non-magnetic, one-component developer of a specific conductivity range. The developers disclosed in the publication improve flowability and shelf stability, but to meet the high resolution requirement, it is required to further improve the printing density and the dot reproducibility.

Japanese Patent Application Laid Open No. 2000-3069 discloses a toner having a specific volume average particle diameter, average circle degree and standard deviation of the circle degree. In addition, Japanese Patent Application Laid-Open No. 1999-344829 discloses a toner produced by suspension polymerization, which has an average circle degree of 0.970 to 0.995. It is described that the above described toners are excellent in dot reproducibility and flowability. However, their electrostatic properties are easily varied and the shelf stability is thus insufficient, causing a problem that toner is agglomerated when storaged under high temperature conditions. Such agglomeration of toner increases the possibility of deficient electrostatic charge, resulting in a problem of degradation of the resolution of developed images and a problem of frequent occurrence of filming.

Japanese Patent Application Laid-Open No. 2003-29459 discloses a toner which is obtained by agglomerating a polymer obtained by emulsion polymerization and has an average circle degree of 0.94 to 0.98 and a gradient of the circle degree to the circle equivalent diameter of −0.005 to −0.001. The toner had a problem that under long term storage, agglomeration occurred and toner properties were degraded.

Accordingly, the object of the present invention is to provide a toner for developing an electrostatic latent image, that is less likely to cause fog and excellent in dot reproducibility and printing characteristics.

### DISCLOSURE OF THE INVENTION

The inventor of the present invention carried out an in-depth study to accomplish the object. As a result, he has found this object can be accomplished by; using a toner for developing an electrostatic latent image comprising a toner particles containing at least a binder resin, a colorant and a charge control agent; controlling the volume mode diameter, the ratio (Dv/Dp) of the volume average particle diameter (Dv) and the number average particle diameter (Dp), average circle degree, the standard deviation of particle diameter, the ratio of an average circle degree of the toner particles having a specific size to the average circle degree of toner particles having a specific size, and further controlling the conductivity of a water extract of the toner or controlling a n-hexane extract component and the methanol extract component into a specific range.

The present invention has been accomplished based on the above finding. According to the present invention, there is provided a toner for developing an electrostatic latent image, comprising a toner particles containing at least a binder resin, a colorant and a charge control agent, the toner particles having a volume mode diameter (a) from 5 to 10 μm, a ratio (Dv/Dp), of a volume average particle diameter (Dv) to a number average particle diameter (Dp), from 1.0 to 1.3, and an average circle degree from 0.97 to 0.995, the toner particles having a standard deviation (b) not more than 2 μm of the particle diameter, the toner particles having a ratio (C1/C2) from 1.00 to 1.02, wherein c1 represents an average circle degree of the toner particles having a particle diameter not less than (a−2b) μm to less than a μm, and c2 represents an average circle degree of the toner particles having a particle diameter not less than a μm and less than (a+2b) μm, wherein a water extract obtained by dispersing the toner in ion exchange water having a conductivity σ1 from 0 to 10 μS/cm so that the toner concentration is 6% by weight, heating to boil the water for 10 minutes, adding separately boiled ion exchange water having a conductivity σ1 from 0 to 10 μS/cm thereto to compensate for evaporated water up to the original volume, and cooling to a room temperature has a conductivity σ2 from 20 μS/cm or less, and σ2−σ1 is from 0.1 to 10 μS/cm.

The present invention also provides a toner for developing an electrostatic latent image, comprising a toner particles containing at least a binder resin, a colorant and a charge control agent, the toner particles having a volume mode diameter (a) from 5 to 10 μm, a ratio (Dv/Dp), of a volume average particle diameter (Dv) to a number average particle diameter (Dp), from 1.0 to 1.3, and an average circle degree from 0.97 to 0.995, the toner particles having a standard deviation (b) not more than 2 μm of the particle diameter of not more than 2 μm, the toner particles having a ratio (C1/C2) from 1.00 to 1.02, wherein c1 represents an average circle degree of the toner particles having a particle diameter not less than (a−2b) μm to less than a μm, and c2 represents an average circle degree of the toner particles having a particle diameter of not less than a μm to less than (a+2b) μm, the toner having a content of a n-hexane extract component in the range from 1 to 15% by weight and a content of a methanol extract component of 5% by weight or less.

The above-mentioned toner for developing an electrostatic latent image is less likely to cause fog and excellent in dot reproducibility and printing characteristics.

The present invention also provides a process for producing a toner for developing an electrostatic latent image, characterized by comprising the steps of; preparing an aqueous dispersion medium containing a colloid of a hardly water-soluble inorganic compound by mixing a water-soluble multivalent inorganic salt and an alkali hydroxide in an aqueous medium and aging the same, adding a polymerizable monomer composition containing a polymerizable monomer, a colorant, a charge control agent and a polymerization initiator to the aged aqueous dispersion medium containing a colloid of a hardly water-soluble inorganic compound, thereby forming droplets of the composition to prepare an aqueous dispersion medium containing droplets, and adding a boron compound to the aqueous dispersion medium containing droplets and then heating the aqueous dispersion medium for polymerizing the polymerizable monomer to form toner particles.

### BEST MODE FOR CARRYING OUT THE INVENTION

A toner for developing an electrostatic latent image according to the present invention is described in detail below.

The toner particles comprising the toner for developing an electrostatic latent image of the present invention comprises at least a binder resin, a colorant and a charge control agent.

As the binder resin, there can be mentioned; resins such as polystyrene, styrene-butyl acrylate copolymers, polyester resins and epoxy resins, which are conventionally commonly used for the toner.

As the colorant, there can be mentioned; any pigments and dyes, including carbon black, titanium black, magnetic powder, oil black, and titanium white. Carbon black having a primary particle diameter in the range from 20 to 40 nm is preferably used as a black colorant. The particle diameter within this range is preferred, because such carbon black can be uniformly dispersed in the toner and fog in printed image developed using the resulting toner decreases.

For a full color toner, a yellow colorant, a magenta colorant and a cyan colorant are generally used.

As the yellow colorant, there can be mentioned; compounds such as azo pigments, and condensed polycyclic pigments. Specific examples of the yellow colorant include pigments such as C.I. Pigment Yellow 3, 12, 13, 14, 15, 17, 62, 65, 73, 74, 83, 90, 93, 97, 120, 138, 155, 180, 181, 185 and 186.

As the magenta colorant, there can be mentioned; compounds such as azo pigments, and condensed polycyclic pigments. Specific examples of the magenta colorant include pigments such as C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, 251, and C.I. Pigment Violet 19.

As the cyan colorant, there can be mentioned; cupper phthalocyanine compounds and their derivatives, anthraquinone compounds and the like. Specific examples of the cyan colorant include pigments such as C.I. Pigment Blue 2, 3, 6, 15, 15:1, 15:2, 15:3, 15:4, 16, 17, and 60.

Any of these colorants is used, preferably, in the amount of 1 to 10 parts by weight per 100 parts by weight of the binder resin.

For forming full color images, toners respectively containing a colorant of three colors of cyan, magenta, yellow and where necessary, black are combined, and development is carried out.

As a charge control agent, a charge control resin is preferable, because charge control resins have high compatibility with binder resins, are colorless, and can provide a toner with a stable charging property even when it is used in high-speed continuous color printing. As the charge control resin, there can be mentioned; quaternary ammonium (salt) group-containing copolymers produced in accordance with the descriptions of Japanese Patent Application Laid-Open Nos. 1988-60458, 1991-175456, 1991-243954, and 1999-15192, and sulfonic acid (salt) group-containing copolymers produced in accordance with the descriptions of Japanese Patent Application Laid-Open Nos. 1989-217464 and 1991-15858.

The amount of the monomer unit having the quaternary ammonium (salt) group or the sulfonic acid (salt) group contained in these copolymers is preferably 0.5 to 15% by weight, more preferably 1 to 10% by weight. If the content of the monomer unit is within this range, the charge level of the toner is easy to control, and the generation of fog in printed image developed using the toner can be minimized.

Preferred as the charge control resin is that having a weight average molecular weight of 3,000 to 300,000, more preferably 4,000 to 50,000, most preferably 6,000 to 35,000.

The glass transition temperature of the charge control resin is preferably 40 to 80° C., more preferably 45 to 75° C., most preferably 45 to 70° C. If the glass transition temperature of the charge control resin is lower than 40° C., the shelf stability of the resulting toner may become deteriorated. If the glass transition temperature exceeds 80° C., fixability of the resulting toner may lower.

The amount of the charge control agent used is generally 0.01 to 30 parts by weight, preferably 0.3 to 25 parts by weight, per 100 parts by weight of the binder resin.

In the present invention, the toner particles preferably further comprises a parting agent. As the parting agent, there can be mentioned; polyolefin waxes such as low molecular weight polyethylene, low molecular weight polypropylene, and low molecular weight polybutylene; natural plant waxes such as candelilla, carnauba, rice, wood wax, and jojoba; petroleum waxes such as paraffin, microcrystalline and petrolatum, as well as waxes modified therefrom; synthetic waxes such as Fischer-Tropsch wax; and polyfunctional ester compounds such as pentaerythritol tetramyristate, pentaerythritol tetrapalmitate, and dipentaerythritol hexamyristate. These parting agents may be used alone or in a combination thereof.

Among these parting agents, synthetic waxes and multifunctional ester compounds are preferred, multifunctional ester compounds are more preferred, which show an endothermic peak temperature within a range of, preferably 30° C. to 150° C., more preferably 40° C. to 100° C., and most preferably 50° C. to 80° C., measured with a DSC curve by means of a differential scanning calorimeter (DSC) at rising temperature, because a toner excellent in a balance between fixing-peeling property during fixing is obtained. In particular, those having a weigh average molecular weight of not less than 1,000 and soluble in styrene at 25° C. in amount of 5 parts by weight or more based on 100 parts by weight of styrene, and having an acid value of 10 mg KOH/g or less, are even more preferred, because it exhibits a distinguished effect in lowering the fixing temperature. The weight average molecular weight of the parting agent is preferably 1,000 to 3,000, more preferably 1,500 to 2,500. The above-mentioned endothermic peak temperatures refer to values measured in accordance with ASTM D3418-82. In addition, the parting agents having a melting point of 40 to 100° C. are preferred, and parting agents having a melting point of 60 to 80° C. are more preferred.

The hydroxyl value of the parting agent is preferably 0 to 5 mg KOH/g, and more preferably 0 to 3 mg KOH/g. If the hydroxyl value of the parting agent exceeds 5 mg KOH, the image property tends to deteriorate.

The amount of the parting agent is generally 0.5 to 50 parts by weight, preferably 1 to 20 parts by weight, per 100 parts by weight of the binder resin.

The toner particle may be a so-called core-shell structure (also called “capsule type”) particle, in which the binder resin for an inner layer of the particle (core layer) is different from the binder resin for an outer layer of the particle (shell layer). The core-shell structure is preferred, because the structure can provide a favorable balance between lowering of the fixing temperature and prevention of aggregation of the toner during storage by covering the low softening point substance as the inner layer (core layer) with a substance having a higher softening point (shell layer).

Generally, the core layer of the core-shell structure particle is composed of the aforementioned binder resin, colorant, charge control resin, and parting agent, while the shell layer is composed of the binder resin alone.

The proportion by weight of the core layer to the shell layer of the core-shell structure particle is not particularly limited, but is generally in the range (core layer/shell layer) of from 80/20 to 99.9/0.1. By using the shell layer in this proportion, good shelf stability and good low temperature fixability of the toner for developing an electrostatic latent image can be fulfilled at the same time.

The average thickness of the shell layer of the core-shell structure particle may be generally 0.001 to 1.0 μm, preferably 0.003 to 0.5 μm, and more preferably 0.005 to 0.2 μm. If the thickness is too large, fixability of the resulting toner may decline. If it is too small, shelf stability of the resulting toner may decline. The core particle constituting the core-shell structure toner particle does not necessarily have all of its surface covered with the shell layer. The surface of the core particle may partly be covered with the shell layer.

The diameter of the core particle and the thickness of the shell layer of the core-shell structure particle can be measured by directly measuring the size and shell thickness of particles which are chosen randomly from photographs taken with an electron microscope, if possible. When it is difficult to observe both of the core and shell layer by an electron microscope, they can be calculated based on the diameter of the core particle and the amount of the monomer used for forming the shell layer at the time of producing the toner for developing an electrostatic latent image.

The toner for developing an electrostatic latent image of the present invention comprises the toner particles having a volume mode diameter (a) of 5 to 10 μm, preferably 5 to 8 μm. If the volume mode diameter (a) is less than 5 μm, flowability of the toner decreases. As a result, fog may be generated in printed image, the toner may partly remain untransferred, or cleaning properties may deteriorate. If the volume mode diameter exceeds 10 μm, reproducibility of fine lines may decline. The volume mode diameter (a) means the mode in diameter distributions based on volume. The volume mode diameter of toner particles may be measured, for example, with flow type particle projection image analyzers such as FPIA-1000 or FPIA-2000, products of Sysmex Corporation.

The toner particles constituting the toner for developing an electrostatic latent image of the present invention has a ratio (Dv/Dp) of a volume average particle diameter (Dv) to the number average particle diameter (Dp) of 1.0 to 1.3, preferably 1.0 to 1.2. If Dv/Dp exceeds 1.3, fog occur in printed image.

The volume average particle diameter and the number average particle diameter of the toner particles can be measured, for example, by use of Multisizer (manufactured by Beckman Coulter, Inc.).

The toner particles constituting the toner for developing an electrostatic latent image according to the present invention have average circle degree of 0.97 to 0.995, preferably 0.975 to 0.995, more preferably 0.98 to 0.995 as measured by a flow particle image analyzer. If the average circle degree is less than 0.97, reproducibility of fine lines is poor in any of an L/L environment (temperature: 10° C., humidity: 20%), an N/N environment (temperature: 23° C., humidity: 50%) or an H/H environment (temperature: 35° C., humidity: 80%).

The average circle degree can be controlled into these range relatively easily by producing the toner by phase-transfer emulsion process, solution suspension process, or polymerization process (suspension polymerization process, emulsion polymerization process), etc.

In the present invention, the circle degree of a particle is defined as a circuit length of the circle which has the same area with the projection of the particle, divided by perimeter length of the projection of the particle. The average circle degree is adopted to represent shapes of the particle quantitatively and simply, and it is an index which shows a degree of the roughness of the particles. If the toner particles are perfectly spherical, the average circle degree equals to 1. The more complicated the surface of the particles are, the smaller the average circle degree becomes. The average circle degree (Ca) is calculated using the second next following formula.

$$Average circularity = ( {\sum }_{i = 1}^{n} ( Ci \times fi ) ) / {\sum }_{i = 1}^{n} ( fi )$$

In the above formula, n represents the number of particles used for calculating the circle degree Ci.

In the above formula, Ci represents the circle degree of each particle in a group of particles having a circle equivalent diameter of 0.6 to 400 μm, which is calculated by the following formula from the measured circuit length of each particle.

Circle degree (Ci)=circuit length of the circle having the same area with the projection of each particle/perimeter length of the projection of each particle

In the above formula, fi denotes frequency of particle having circle degree Cᵢ.

The Circle degree and the average circle degree may be measured with flow type particle projection image analyzers, such as FPIA-1000 or FPIA-2000, products of Sysmex Corporation.

The standard deviation (b) of the particle diameter of the toner particles constituting the toner for developing an electrostatic latent image according to the present invention is 2 μm or less, preferably, 1.5 μm or less. If the standard deviation of the particle diameter of the toner particles exceeds 2 μm, deterioration of image quality such as occurrence of fog may arise. The standard deviation of the particle diameter of the toner particles is calculated from distribution based on volume, which is a value on a volume basis that may be measured with flow type particle projection image analyzers, such as FPIA-1000 or FPIA-2000 products of Sysmex Corporation as in the case of measuring circle degree and average circle degree.

The toner particles constituting the toner for developing an electrostatic latent image according to the present invention has a (C1/C2) of 1.00 to 1.02, preferably, 1.00 to 1.01, when the volume mode diameter is defined as “a” and the standard deviation of particle diameter of toner particles is defined as “b”, and the average circle degree of toner particles having a particle diameter of not less than (a−2b) μm to less than a μm is defined as C1 and the average circle degree of toner particles having a particle diameter of not less than a μm to less than (a+2b) μm is defined as C2. This value indicates a coalescent state of toner particles. A greater C1/C2 indicates that the number of so-called coalescent particles in which two toner particles are fused is great. If (C1/C2) is within the above-mentioned range, fog is less likely to occur, the dot reproducibility is improved and excellent image quality can be obtained.

The above-mentioned C1 and C2 can also be measured with flow type particle projection image analyzers, such as FPIA-1000 or FPIA-2000 products of Sysmex Corporation as in the case of measuring circle degree and average circle degree.

Regarding the toner for developing an electrostatic latent image according to the first embodiment of the present invention, a water extract obtained by dispersing the toner in ion exchange water having a conductivity σ1 of 0 to 10 μS/cm so that the toner concentration is 6% by weight, heating to boil the water for 10 minutes, adding separately boiled ion exchange water having a conductivity σ1 of 0 to 10 μS/cm to compensate for evaporated water up to the original volume, and cooling to a room temperature (about 22° C.), has a conductivity σ2 of 20 μS/cm or less, preferably 10 μS/cm or less. In addition, σ2−σ1 is 0.1 to 10 μS/cm, preferably 0.1 to 6 μS/cm. If the conductivity 2 exceeds 20 μS/cm, the amount of electrostatic charge is highly dependent on environment, causing deterioration of image quality due to environmental changes (changes in temperature and humidity). If σ2−σ1 exceeds 10 μS/cm, the amount of electrostatic charge is also highly dependent on environment, causing deterioration of image quality due to environmental changes (changes in temperature and humidity). On the other hand, if σ2−σ1 is less than 0.1 μS/cm, the printing density may be decreased and fog may occur.

The toner for developing an electrostatic latent image according to the present invention has an enthalpy of fusion (ΔH) of preferably 1 to 10 mJ/mg, more preferably 2 to 6 mJ/mg, particularly preferably 3 to 5 mJ/mg, as measured by a differential scanning calorimeter (DSC). If the enthalpy of fusion (ΔH) of the toner for developing an electrostatic latent image measured by a differential scanning calorimeter is within the above-mentioned range, the fixing property is excellent. If ΔH exceeds 10 mJ/mg, a large amount of calories is necessary for fusing the toner, sometimes failing to achieve low energy fixing (low temperature fixing) when forming images in multiple colors and multiple layers as informing color images. If ΔH is less than 1 mJ/mg, the fixing property may be poor and a sufficient releasing effect may not be obtained. ΔH can be calculated from the area (peak area) of a region surrounded by an endothermic peak and a baseline in a DSC curve.

As for the toner for developing the electrostatic latent image according to the second embodiment of the present invention, the content of a n-hexane extract component of the toner is 1 to 15% by weight, preferably 3 to 13% by weight. If the content of the n-hexane extract component is less than 1% by weight, the fixing temperature may be increased. On the other hand, if the content exceeds 15% by weight, the shelf stability may be decreased. The content of the n-hexane extract component can be measured according to the method described later.

As for the toner for developing an electrostatic latent image according to the second embodiment of the present invention, the content of the methanol extract component of the toner is 5% by weight or less, preferably 4% by weight or less. If the content of the methanol extract component exceeds 5% by weight, the toner becomes hygroscopic, and the environmental stability (reproducibility of fine lines) may be decreased and fog may occur. The content of the methanol extract component can be measured according to the method described later.

The toner for developing the electrostatic image according to the present invention can be used, as it is, for development in electrophotography. Generally, however, it is preferable that the toner is used after fine particles having a smaller particle diameter than that of the toner particles (the fine particles will be referred to hereinafter as an external additive) are adhered to or buried into the surfaces of the toner particles, in order to adjust the charging properties, flowability and shelf stability of the toner.

Examples of the external additive are inorganic particles and organic resin particles which are generally used for improving flowability and charging properties. These particles, added as the external additives, have a smaller average particle diameter than that of the toner particles. Specific examples of the inorganic particles include silica, aluminum oxide, titanium oxide, zinc oxide, and tin oxide. Specific examples of the organic resin particles include methacrylic ester polymer particles, acrylic ester polymer particles, styrene-methacrylic ester copolymer particles, styrene-acrylic ester copolymer particles, core-shell structure particles having a core formed of a styrene polymer and a shell formed of a methacrylic ester polymer. Of these particles, silica particles and titanium oxide particles are preferred. These particles having their surface hydrophobicitizing-treated are more preferred, and hydrophobicitizing-treated silica particles are even more preferred. The amount of the external additive is not particularly limited, but is generally 0.1 to 6 parts by weight per 100 parts by weight of the toner particles.

The toner for developing the electrostatic image according to the present invention is preferably produced by a polymerization method, although the method of production is not limited, as long as it can provide a toner having the properties within the above-mentioned preferred ranges.

The followings are detailed description about the method of producing toner particles constituting the toner for developing the electrostatic image by the polymerization method.

The toner particles constituting the toner for developing an electrostatic latent image according to the present invention can be produced, for example by a method of producing a toner for developing an electrostatic latent image, characterized by comprising the steps of preparing an aqueous dispersion medium containing a colloid of a hardly water-soluble inorganic compound by mixing a water-soluble multivalent inorganic salt and an alkali hydroxide in an aqueous medium and aging the same, adding a polymerizable monomer composition containing a polymerizable monomer, a colorant, a charge control agent and a polymerization initiator to the aged aqueous dispersion medium containing a colloid of a hardly water-soluble inorganic compound, thereby forming droplets of the composition to prepare an aqueous dispersion medium containing droplets, and adding a boron compound to the aqueous dispersion medium containing droplets and then heating the aqueous dispersion medium for polymerizing the polymerizable monomer to form toner particles.

In the present invention, to obtain the polymerizable monomer composition, it is preferable to mix the colorant and the charge control resin to obtain a charge control resin composition, and add the charge control resin composition in advance, together with the parting agent, to the polymerizable monomer, followed by mixing these components. The amount of the colorant is generally 10 to 200 parts by weight, preferably 20 to 150 parts by weight, per 100 parts by weight of the charge control resin.

To prepare the charge control resin composition, the use of an organic solvent is preferable. By using the organic solvent, the charge control resin softens and is easily mixable with the pigment.

The amount of the organic solvent is generally 0 to 100 parts by weight, preferably 5 to 80 parts by weight, and more preferably 10 to 60 parts by weight, per 100 parts by weight of the charge control resin. Within this range, an excellent balance between dispersibility and processability of the polymerizable monomer composition is obtained. The organic solvent may be added either at one time or dividedly upon observing the condition of the mixture.

Mixing of the charge control resin and the colorant may be performed using equipment such as a roll, a kneader, a single screw extruder, a twin screw extruder, a Banbury mixer, a Buss co-kneader, and the like. When an organic solvent is used, it is preferred to use the mixing equipment in a closed system with a structure which prevents leakage of the organic solvent to the outside. Moreover, it is preferable to use the mixing equipment furnishing a torque meter, because the torque meter enables to monitor and control the dispersibility.

As a polymerizable monomer, a raw material of the binder resin, there can be mentioned, for instance, a monovinyl monomer, a cross-linkable monomer and a macromonomer. These polymerizable monomers become the binder resin component after polymerization. Specific examples of the monovinyl monomers include; aromatic vinyl monomers such as styrene, vinyltoluene, and α-methylstyrene; acrylic acid and its derivatives such as methyl acrylate, ethyl acrylate, propyl acrylate, butyl acrylate, 2-ethylhexyl acrylate, cyclohyxl acrylate, isobonyl acrylate; methacrylic acid and its derivatives such as methyl methacrylate, ethyl methacrylate, propyl methacrylate, butyl methacrylate, 2-ethylhexyl methacrylate, cyclohexyl methacrylate, isobonyl methacrylate; and mono olefin monomers such as ethylene, propylene and butylenes; and the like.

The monovinyl monomers may be used alone or in a combination thereof. Among the monovinyl monomers as mentioned above, it is preferable to use aromatic vinyl monomers alone, or to use aromatic vinyl monomers in a combination with acrylic acid derivatives or methacrylic acid derivatives.

The use of the crosslinkable monomer in a combination with the monovinyl monomer effectively improves hot offset resistance of the resulting toner. The crosslinkable monomer is a monomer having two or more vinyl groups. As specific examples of the crosslinkable monomer, there can be mentioned; divinylbenzene, divinylnaphthalene, pentaerythritol triallyl ether, and trimethylolpropane triacrylate. These crosslinkable monomers may be used alone or in a combination thereof. The amount of the crosslinkable monomer is generally 10 parts by weight or less, preferably 0.1 to 2 parts by weight, per 100 parts by weight of the monovinyl monomer.

It is preferable to use a macromonomer together with the monovinyl monomer, because this use provides a satisfactory balance between shelf stability and fixability at a low temperature. The macromonomer is an oligomer or polymer having a polymerizable carbon-carbon unsaturated double bond at its molecular chain terminal and a number average molecular weight of generally from 1,000 to 30,000.

The macromonomer is preferably the one which gives a polymer, by polymerization alone, having a glass transition temperature higher than that of a polymer obtained by polymerizing the above-mentioned monovinyl monomer alone.

The amount of the macromonomer used is generally 0.01 to 10 parts by weight, preferably 0.03 to 5 parts by weight, more preferably 0.05 to 1 part by weight, per 100 parts by weight of the monovinyl monomer.

As examples of the polymerization initiator, there can be mentioned; persulfates such as potassium persulfate and ammonium persulfate; azo compounds such as 4,4′-azobis-(4-cyanovaleric acid), 2,2′-azobis-(2-methyl-N-(2-hydroxyethyl))propionamide, 2,2′-azobis-(2-amidinopropane) bihydrochloride, 2,2′-azobis-(2,4-dimethyl valeronitrile), and 2,2′-azobis-isobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, and t-butyl peroxyisobutyrate. Redox initiators, composed of combinations of these polymerization initiators with a reducing agent, may also be used.

The amount of the polymerization initiator used in the polymerization of the polymerizable monomer composition is preferably 0.1 to 20 parts by weight, more preferably 0.3 to 15 parts by weight, and most preferably 0.5 to 10 parts by weight, per 100 parts by weight of the polymerizable monomer. The polymerization initiator may be added to an aqueous dispersion medium after forming droplets, but it is more preferable to add the polymerization initiator to the polymerizable monomer composition in advance.

The colloid of hardly water-soluble inorganic compound used as a dispersion stabilizer is produced by mixing a water-soluble multivalent inorganic salt and an alkali metal hydroxide in an aqueous dispersion medium. As the hardly water-soluble inorganic compound, there can be mentioned magnesium hydroxide. Use of the aqueous dispersion medium containing a colloid of a hardly water-soluble inorganic compound for toner production after aging is preferred because the toner for developing an electrostatic latent image of the present invention can be easily obtained. In the present invention, aging means leaving the aqueous dispersion medium containing a colloid of a hardly water-soluble inorganic compound for a pre-determined time after preparation, not using it immediately. Specifically, the aqueous dispersion medium is allowed to stand at a temperature of 15 to 35° C., preferably 20 to 35° C. for 4 to 18 hours, preferably 5 to 20 hours.

The amount of the above-mentioned dispersion stabilizer is preferably 0.1 to 20 parts by weight based on 100 parts by weight of the polymerizable monomer. If the amount of the dispersion stabilizer is lower than 0.1 parts by weight, sufficient polymerization stability is difficult to achieve and polymerization aggregate tends to be generated. On the other hand, If the amount used exceeds 20 parts by weight, the effect of stabilizing polymerization is uneconomically saturated, and in addition, the viscosity of the aqueous dispersion medium becomes too high, making it difficult to form small droplets in the step of forming droplets of a polymerizable monomer composition.

Upon polymerization, a water-soluble polymer may be used together within the range in which environmental dependency of electrostatic properties and fixing properties of polymerized toner are not significantly changed. As the water-soluble polymer, there can be mentioned; polyvinyl alcohol, methylcellulose and gelatin.

Upon polymerization, after forming droplets of a polymerizable monomer, an aqueous solution of a boron compound may be added to the aqueous dispersion medium containing droplets. As the boron compound, there can be mentioned; boron trifluoride, boron trichloride, tetrafluoroboric acid, sodium tetrahydroborate, potassium tetrahydroborate, sodium tetraborate, sodium tetraborate decahydrate, sodium metaborate, sodium metaborate tetrahydrate, sodium peroxoborate tetrahydrate, boric acid, potassium metaborate and potassium tetraborate octahydrate. The boron compound is preferably added in the form of an aqueous solution. The amount of the boron compound is preferably 0.1 to 5 parts by weight, more preferably 0.3 to 3 parts by weight based on 100 parts by weight of the colloid of a hardly water-soluble inorganic compound.

Further, upon polymerization, a molecular weight modifier is preferably used. As the molecular weight modifier, there can be mentioned; mercaptans such as t-dodecyl mercaptan, n-dodecyl mercaptan, n-octyl mercaptan and 2,2,4,6,6-pentamethylheptane-4-thiol and the like. The molecular weight modifier may be added before or during polymerization reaction. The molecular weight modifier is used preferably 0.01 to 10 parts by weight, and more preferably 0.1 to 5 parts by weight, per 100 parts by weight of the polymerizable monomer used.

No limitation is imposed on a method for producing the core-shell structure toner particles, and these toner particles can be produced by a publicly known method. For example, a method such as spray-drying method, interfacial reaction method, in-situ polymerization method, or phase separation method may be named. Specifically, toner particles obtained by pulverization, polymerization, association or phase inversion emulsification as core particles are covered with a shell layer to prepare core-shell toner particles. Of these methods, the in-situ polymerization method and phase-separation method are preferable because of their efficient productivity.

The method for producing the core-shell structure toner particles using the in-situ polymerization process is described in detail below.

A polymerizable monomer to form a shell (polymerizable monomer for shell) and a polymerization initiator are added to an aqueous dispersion medium including core particles dispersed therein, and the mixture is polymerized to obtain the core-shell structure toner particles.

As specific examples of the process for forming the shell, there can be mentioned; a process comprising adding a polymerizable monomer for a shell to a production system of a polymerization reaction which has been conducted for preparing core particles to continuously conduct polymerization; and a process comprising introducing core particles prepared in a different production system and adding a polymerizable monomer for a shell thereto to conduct polymerization.

The polymerizable monomer for shell may be provided into the reaction system at one time, or may be provided continuously or dividedly using a pump such as a plunger pump.

As the polymerizable monomer for shell, monomers capable of forming a polymer having a glass transition temperature of higher than 80° C. by polymerization alone, such as styrene, acrylonitrile and methyl methacrylate, may be used alone or in a combination thereof.

When the polymerizable monomer for shell is added to the reaction system, a water-soluble polymerization initiator is preferably added, because this addition makes it easy to obtain the core-shell structure toner particles.

It is speculated that when the water-soluble polymerization initiator is added during addition of the polymerizable monomer for shell, the water-soluble polymerization initiator migrates to the vicinity of outer surface of core particle, thereby facilitating polymerization of the polymerizable monomer for a shell on the surface of the core particle.

As the water-soluble polymerization initiator; there can be mentioned; persulfates such as potassium persulfate, and ammonium persulfate; azo compounds such as 2,2′-azobis-(2-methyl-N-(2-hydroxyethyl)propionamide), and 2,2′-azobis-(2-methyl-N-(1,1′-bis(hydroxymethyl)-2-hydroxyethyl)propionamide. The amount of the water-soluble polymerization initiator is generally 0.1 part to 50 parts by weight, preferably 1 to 30 parts by weight, per 100 parts by weight of the polymerizable monomer for shell.

The temperature during polymerization is preferably 50° C. or higher, more preferably 80 to 95° C. The polymerization reaction time is preferably 1 to 20 hours, more preferably 2 to 10 hours. After completion of the polymerization, a procedure comprising filtration, washing, dehydration and drying is preferably repeated several times, as desired, in accordance with the conventional methods.

If the colloid of inorganic compound is used as the dispersion stabilizer, the colloid of a hardly water-soluble inorganic compound is preferably dissolved by adding acid so that the pH of an aqueous dispersion of toner particles to be obtained by polymerization is pH 6.5 or lower. An inorganic acid, such as sulfuric acid, hydrochloric acid or nitric acid; or an organic acid, such as formic acid or acetic acid; can be used as the acid to be added. Sulfuric acid is particularly preferable, because it has a high efficiency of its removal and its burden on production facilities is light.

There is no limitation on the method of filtering toner particles from the aqueous dispersion medium for dehydration. For example, centrifugal filtration, vacuum filtration or pressurized filtration can be named. Of these methods, centrifugal filtration is preferable.

The toner for developing an electrostatic image according to the present invention is obtained by mixing the toner particles and the external additive and, if desired, other fine particles by means of a high speed stirrer such as a Henschel mixer.

### EXAMPLES

The present invention is hereinafter to be described more specifically by the following examples. Such examples, however, are not to be construed as limiting in any way the scope of the present invention. All designations of “part” or “parts” and “%” used in the following examples mean part or parts by weight and wt. % unless expressly noted.

In the examples, the toner for developing an electrostatic image was evaluated by the following tests.

### (1) Particle Diameter and Particle Diameter Distribution

The particle diameter distribution of toner particles, i.e., the ratio (Dv/Dp) of a volume average particle diameter to a number average particle diameter (Dp) was measured by means of a particle diameter measuring device (“Multisizer”, manufactured by Beckman Coulter Inc.). The measurement by the Multisizer was conducted under the following conditions:

Aperture diameter: 100 μm;

Medium: Isothone II;

Concentration: 10% and

Number of particles measured: 50,000 particles.

### (2) Volume Mode Diameter, Average Circle Degree, and Standard Deviation

After adding 100 μl of a 0.1% anionic surfactant aqueous solution to 20 mg of toner particles as a dispersion medium so that the particles got wet with the solution, 10 ml of water was added thereto, followed by stirring. The volume mode diameter, the average circle degree and the standard deviation were then measured by a flow type particle projection image analyzer (FPIA-2000, manufactured by Sysmex Corp.). Analysis was carried out on a volume basis (for groups of 15 μm or less).

Further, the average circle degree (C1) of toner particles having a particle diameter of not less than (a−2b) μm to less than a μm and the average circle degree (C2) of toner particles having a particle diameter of not less than a μm to less than (a+2b) μm were also measured by the above-mentioned analyzer.

### (3) Conductivity

6 g of toner was dispersed in ion exchange water (σ1 being 0.8 μS/cm; pH=7) to prepare 100 g of a dispersion. After heating and boiling the dispersion and maintaining the boiling state for about 10 minutes (10 minute boiling), ion exchange water (σ1 being 0.8 μS/cm; pH=7) which was separately boiled for 10 minutes was supplied thereto up to the pre-boiling volume. The resultant was cooled to a room temperature (about 22° C.) and the conductivity σ2 of the extract was measured. The conductivity σ1 of the ion exchange water used was measured to calculate σ2−σ1. Conductivities were measured using Conductivity Meter “ES-12” (manufactured by Horiba Ltd.)

### (4) Enthalpy of Fusion

The enthalpy of fusion was calculated from the peak area in a DSC curve measured using a differential scanning calorimeter (DSC SSC5200, manufactured by Seiko Instruments Inc.) in accordance with ASTM D3418-82 at a temperature increase rate of 10° C./minute.

(5) A Content of an n-Hexane Extract Component

1.0 g of the toner for developing an electrostatic latent image and 100 ml of n-hexane were placed in a Soxhlet extractor in which an extraction thimble (cylindrical filter paper; No. 86R, manufactured by Toyo Roshi Ltd.) was set, and the mixture was refluxed at normal pressure for 6 hours to give an extract. The solvent was evaporated from the extract and the solid component was vacuum-dried at a temperature of 50° C. for 1 hour and weighed. This weighed value was divided by the initially weighed value of the toner for developing an electrostatic latent image, and the obtained value was multiplied by 100 to be defined as the content (%) of an n-hexane extract component.

### (6) A Content of a Methanol Extract Component

1.0 g of the toner for developing an electrostatic latent image and 100 ml of methanol were placed in a Soxhlet extractor in which an extraction thimble (cylindrical filter paper; No. 86R, manufactured by Toyo Roshi Ltd.) was set, and the mixture was refluxed at normal pressure for 6 hours to give an extract. The solvent was evaporated from the extract and the solid component was vacuum-dried at a temperature of 50° C. for 1 hour and weighed. This weighed value was divided by the initially weighed value of the toner for developing an electrostatic latent image, and the obtained value was multiplied by 100 to be defined as the content (%) of a methanol extract component.

### (7) Flowability

Three sieves with aperture sizes of 150 μm, 75 μm and 45 μm, respectively, were stacked, in this order with the 150 μm sieve laid at the top. A sample (toner for developing an electrostatic latent image, 4 g) was accurately weighed and placed on the sieve at the top. Then, the three stacked sieves were vibrated for 15 seconds with vibration intensity of 4 with the use of a powder measuring device (trade name: Powder Tester, manufactured by Hosokawa Micron Ltd.), and then the weight of the toner for developing an electrostatic latent image remaining on each sieve was measured. The measured values were substituted into the following equations for calculation to determine values of flowability.

The measurement was made three times for one sample, and the average of the measured values was obtained.

### Equations for Calculation:

a=(weight (g) of the toner for developing an electrostatic latent image remaining on the sieve of the aperture size 150 μm)/4 (g)×100;

b=(weight (g) of the toner for developing an electrostatic latent image remaining on the sieve of the aperture size 75 μm)/4 (g)×100×0.6;

c=(weight (g) of the toner for developing an electrostatic latent image remaining on the sieve of the aperture size 45 μm)/4 (g)×100×0.2; and

Flowability (%)=100−(a+b+c).

### (8) Fog

Recycled paper was set in a commercially available non-magnetic-one-component developing type printer (18-sheet/min machine), and the toner for developing an electrostatic image was put in a developing device of the printer. The toner for developing an electrostatic image was left standing over a day and a night under the (L/L) environment of a temperature of 10° C. and a humidity of 20%, the (N/N) environment of a temperature of 23° C. and a humidity of 50%, or (H/H) environment of a temperature of 35° C. and a humidity of 80%. Then, printing was continuously performed at a image density of 5% from the beginning, and the printing was suspended every 500 pieces of paper. The developed toner for developing an electrostatic image on the photoconductive member was stripped off and collected by sticking with an adhesive tape (trade name: Scotch Mending Tape 810-3-18, manufactured by Sumitomo 3M Limited). Then the adhesive tape was pealed to stick it on a new sheet of paper to measure “whiteness (B),” using a whiteness checker (manufactured by Nippon Denshoku Industries Co., Ltd.). At the same time, as a control, an adhesive tape alone was attached on another new sheet of paper to measure “whiteness (A)”, and the difference in whitenesses (A−B) was calculated. The maximum number of sheets of paper where the difference between the above value and the whiteness difference (A−B) (%) at initial printing (10 printing sheets) was not more than 1% was counted (counted per 500 sheets). The test printing was terminated when the number of sheets reached 10,000.

### (9) Reproducibility of Fine Lines

Using the printer used in (8), the toner was left standing over a day and night under the (L/L) environment of a temperature of 10° C. and a humidity of 20%, the (N/N) environment of a temperature of 23° C. and a humidity of 50% and the (H/H) environment of a temperature of 35° C. and a humidity of 80% overnight. Line images were continuously formed at a 2×2 dotline (width: about 85 μm), and measurement was conducted every 500 sheets using printing evaluation system “RT2000” (manufactured by YA-MA Co., Ltd.) to collect data of the density distribution of the line images. At this time, all line widths with a density half the maximum density were measured as line widths, and those having a difference between the line width of the line images of the first sheet and the line width of the line images of the 500th sheet of not more than 10 μm were considered to be capable of reproducing the line images of the first sheet, and the maximum number of sheets that could maintain the difference between the line width of the line images of the first sheet and the line width of the line images of the 500th sheet of not more than 10 μm was counted. The test printing was terminated when the number of sheets reached 10,000.

### (10) Image Density

Printing paper was set in the printer used in (8), and a toner for developing an electrostatic image was put in a developing device of the printer. The toner for developing an electrostatic image was left standing over a day and a night under the (H/H) environment of a temperature of 35° C. and a humidity of 80%. Then, an image density was set to a 5%, and continuous printing was conducted from the initial period, and black printing was performed at 100 sheets (initial printing), and 10,000 sheets (continuous) printing to measure for image density using a McBeth reflection densitometer.

### (11) Shelf Stability

A sealable container was provided with the toner for developing an electrostatic image, closed and sealed. Then, the container was submerged in a thermostatic water chamber at a temperature of 55° C. and for 8 hours, and then the container was taken out. The toner for developing the electrostatic image was taken out from the container onto a 42-mesh sieve carefully to avoid destruction of its structure minimally. This sieve was vibrated for 30 seconds with the use of a powder measuring device used in (6), with the vibration intensity of 4.5. Then, the weight of the toner remaining on the sieve was measured, and the measured value was taken as the weight of the aggregated toner. The proportion of the weight (wt. %) of the aggregated toner to the weight of the toner initially placed in the container was calculated. The measurement was made three times for one sample, and the average of the measured values was obtained and used as an index of shelf stability. The shelf stability of the toner is better as it shows a smaller value (wt. %).

### (12) The Toner Fixing Temperature

A fixing test was conducted using a commercially available nonmagnetic one-component development type printer (18-sheet/min machine) modified such that the temperature of its fixing roll portion would be variable. The fixing test was performed by varying the temperature of the fixing roll of the modified printer by 5° C. at a time, and measuring the fixing rate of the developer at each temperatures to determine the relationship between the temperature and the fixing rate. The fixing rate was calculated from the ratio of image density after a tape peeling treatment to that before the treatment in a black printing area in a test sheet printed by the modified printer. That is, the fixing rate was calculated from the following equation:

Fixing rate (%)=(ID_{After}/ID_{Before})×100

where ID_{Before} represents the image density before tape peeling, and ID_{After} represents the image density after tape peeling.

The tape peeling treatment means a series of steps consisting: applying an adhesive tape (Scotch Mending Tape 810-3-18, manufactured by Sumitomo 3M Limited) to a portion of the test sheet to be measured, pressing the adhesive tape by a 500 g steel roller for adhesion, and then peeling the adhesive tape at a constant speed in a direction along the sheet. The image density was measured by use of a Macbeth's reflection type image density measuring device. The toner fixing temperature denotes the temperature of the fixing roll at which the fixing rate became 80% in the fixing test.

(13) Hot offset

As in the measurement of the toner fixing temperature in test (12), the temperature of the fixing roll was varied by 5° C. at a time, and printing was done at each temperature. Hot off set resistance denotes the temperature at which the toner becomes to remain on the fixing roll to generate soil.

### Example 1

100 parts of polymerizable monomers composed of 90.5 parts of styrene, 9 parts of n-butylacrylate and 0.5 part of 2-acrylamido-2-methylpropanesulfonic acid was poured into 900 parts of toluene. The mixture was allowed to react at 80° C. for 8 hours in the presence of 4 parts of azobisdimethylvaleronitrile. After completion of the reaction, toluene was removed under reduced pressure to give a sulfonic acid group-containing copolymer (Mw=16,000) as a negative charge control resin.

6 parts of the above-mentioned sulfonic acid group-containing copolymer as a negative charge control resin and 6 parts of carbon black (trade name “#25B”, manufactured by Mitsubishi Chemical Corporation; primary particle diameter 40 nm) was dissolved in 83 parts of styrene, 17 parts of n-butylacrylate and 0.6 part of divinylbenzene. Subsequently, 1 part of t-dodecylmercaptan and 10 parts of dipentaerythritolhexamyristate were dispersed with a bead mill at room temperature to give a homogeneous mixture. To the aforementioned mixture was added 5 parts of t-butyl peroxy-2-ethylhexanoate (trade name “Perbutyl O”, manufactured by NOF Corporation) as a polymerization initiator to give a polymerizable monomer composition.

Separately, 2 parts of methyl methacrylate and 65 parts of water were mixed to obtain an aqueous dispersion of a polymerizable monomer for shell.

At the same time, an aqueous solution containing 5.5 parts of sodium hydroxide dissolved in 50 parts of ion-exchanged water was gradually added to an aqueous solution containing 9.5 parts of magnesium chloride dissolved in 250 parts of ion-exchanged water, with stirring, to prepare a magnesium hydroxide colloidal dispersion. The magnesium hydroxide colloidal dispersion was allowed to stand at 25° C. for 6 hours to be aged. The polymerizable monomer composition was poured into the aged dispersion, and the mixture was stirred at 15,000 rμm for 10 minutes by a continuous emulsifier/disperser, Ebara Milder MDN304 (manufactured by EBARA Corp.), thereby forming droplets of the polymerizable monomer composition (monomer composition for a core). To the obtained colloidal dispersion of magnesium hydroxide in which the monomer composition for a core was dispersed was added 1 part of sodium tetraborate decahydrate, and the mixture was put in a reactor equipped with a stirring blade, and a polymerization reaction was started at 85° C. After the polymerization conversion reached about 100%, the aqueous dispersion of a polymerizable monomer for a shell and 0.3 part of 2,2′-azobis(2-methyl-N(2-hydroxyethyl)-propionamide (manufactured by Wako Pure Chemical Industries, Ltd., trade name “VA-086”) was poured into the reactor. After continuing the polymerization reaction for 4 hours, the reaction was terminated to give an aqueous dispersion of core-shell toner particles.

The pH system was adjusted to 4 or lower, by adding sulfuric acid to the aqueous dispersion of core-shell structure toner particles at 25° C., and stirred for 10 minutes. This dispersion was then dehydrated by filtration. Then, obtained toner particles and 500 parts of water were mixed to form slurry again and conduct washing with water at 38° C. Thereafter, solid content was separated by filtration and dried with a dryer for 2 days and nights at 45° C., whereby toner particles were obtained.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a negatively charged toner for developing an electrostatic image. The thus obtained toner for developing the electrostatic image was evaluated in the above manner. The results are shown in Table 1.

### Example 2

100 parts of polymerizable monomers composed of 89 parts of styrene, 9 parts of n-butylacrylate and 2 parts of N-benzyl-N,N-dimethyl-N-(2-methacryloxyethyl)ammonium chloride was poured into 900 parts of toluene, and the mixture was allowed to react at 80° C. for 8 hours in the presence of 4 parts of azobisdimethylvaleronitrile. After completion of the reaction, toluene was removed under reduced pressure to give a quaternary ammonium salt group-containing copolymer (Mw=25,000) as a positive charge control resin.

A toner for developing the electrostatic image was obtained in the same way as in Example 1, except that the negative charge control resin was replaced by the above-mentioned positive charge control resin. The properties of the resulting toner for developing the electrostatic image were evaluated in the above manner. The results are shown in Table 1.

### Comparative Example 1

A polymerizable monomer for core composed of 80.5 parts of styrene and 19.5 parts of n-butylacrylate (Tg of a copolymer obtained by co-polymerizing these monomers=55° C.), 0.3 part of a polymethacrylic ester macromonomer (manufactured by Toagosei Co., Ltd., trade name “AA6”, Tg=94° C.), 0.5 part of divinylbenzene, 1.2 parts of t-dodecyl mercaptane, 7 parts of carbon black (manufactured by Mitsubishi Chemical Corporation, trade name “#25B”), 1 part of a charge control agent (manufactured by Hodogaya Chemical Co., Ltd., trade name “Spilon Black TRH”) and 2 parts of a parting agent (Fischer Tropsch wax, manufactured by Sasol, trade name “Paraflint Spray 30”, endothermic peak: 100° C.) were poured into a stirring container of a media-type wet grinder, thereby subjecting the parting agent to wet grinding to obtain a polymerizable monomer composition for core.

Separately, 2 parts of methyl methacrylate (Tg=105° C.) and 100 parts of water were subjected to finely-dispersing treatment using an ultrasonic emulsifier to obtain an aqueous dispersion of a polymerizable monomer for shell.

At the same time, an aqueous solution containing 6.2 parts of sodium hydroxide dissolved in 50 parts of ion-exchanged water was gradually added to an aqueous solution containing 10.2 parts of magnesium chloride dissolved in 250 parts of ion-exchanged water, with stirring, and 20 parts of an aqueous 5% sodium tetraborate decahydrate solution was added thereto to prepare a magnesium hydroxide colloidal dispersion.

The above polymerizable monomer composition for core and t-butyl peroxy-2-ethylhexanoate (trade name: Perbutyl O, manufactured by NOF Corporation) were poured into the obtained colloidal dispersion of magnesium hydroxide, and the mixture was passed through Ebara Milder (trade name: MDN303V, manufactured by EBARA Corp.) rotating at 15,000 rμm in a total residence time of 3 seconds. The dispersion passed was circulated by returning it into the stirring bath via an inner nozzle at an ejection rate of 0.5 m/s to form droplets of the polymerizable monomer composition for core. The system was then heated to 90° C. to start a polymerization reaction. At the time the conversion of the monomer into a polymer reached about 100%, 0.3 part of 2,2′-azobis(2-methyl-N-(2-hydroxyethyl)-propionamide (manufactured by Wako Pure Chemical Industries, Ltd., trade name: VA-086) was dissolved in the above aqueous dispersion of the polymerizable monomer for shell, and the mixture was poured into the reactor. After the polymerization reaction was continued for 4 hours, the reaction was stopped, to obtain an aqueous dispersion of core-shell structure toner particles. A toner for developing the electrostatic image was obtained in the same way as in Example 1, except that the above-mentioned core-shell structure toner particles. The properties of the resulting toner for developing the electrostatic image were evaluated in the above manner. The results are shown in Table 2.

### Comparative Example 2

A four-neck flask was equipped with a reflux condenser, a water separator, a nitrogen gas inlet tube, a thermometer and a stirrer, and placed in a mantle heater. The flask was charged with a monomer composition containing 5 parts of bisphenol A-EO adduct, 5 parts of bisphenol A-PO adduct, 4 parts of terephthalic acid and 5 parts of fumaric acid, and with introducing nitrogen into the flask, a reaction was conducted by heating and stirring to give a polyester resin.

Subsequently, 70 parts of the polyester resin obtained as described above and 30 parts of carbon black (tradename “#25B”, manufactured by Mitsubishi Chemical Corporation; primary particle diameter: 40 nm) were charged into a pressure kneader and mixed. The obtained mixture was cooled and then pulverized by a feather mill to give a pigment masterbatch.

In the next place, 93 parts of the polyester resin, 10 parts of pigment masterbatch, which were obtained as described above, 2 parts of zinc salicylate metal complex (manufactured by Orient Chemical Industries, Ltd., trade name “E84”) and 2 parts of oxidized low molecular weight polypropylene (manufactured by Sanyo Chemical Industries, Ltd., trade name “Viscol TS200”) were mixed sufficiently by a Henschel mixer. The mixture was melt-kneaded by a twin-screw extrusion kneader, and the resulting kneaded product was immediately cooled and coarsely pulverized by a feather mill. The coarsely pulverized product was subjected to coarse particle classification by a jet mill (manufactured by Nippon Pneumatic Mfg. Co., Ltd., trade name “IDS”), and then fine particle classification by a DS classifier (manufactured by Nippon Pneumatic Mfg. Co., Ltd.) to give toner base particles.

To 100 parts of the obtained toner base particles were added 0.5 part of hydrophobic silica TS500 (manufactured by Cabosil Co. Ltd., BET specific surface area: 225 m²/g) and 0.3 part by weight of hydrophobic silica NAX50 (Nippon Aerosil Co., Ltd., BET specific surface area: 40 m²/g), and mixing was conducted using a Henschel mixer at a peripheral speed of 30 m/sec for 90 seconds. Subsequently, using a surface modification apparatus (Surfusing system, manufactured by Nippon Pneumatic Mfg. Co., Ltd.), surface modification of the toner base particles was carried out under conditions of highest temperature: 250° C., residence time: 0.5 second, powder dispersion density: 100 g/m³, cooling air temperature: 18° C. and cooling water temperature: 10° C. To 100 parts of toner base particles were added 0.5 part of hydrophobic silica R972 (manufactured by Nippon Aerosil Co., Ltd., BET specific surface area 110 m²/g) and 0.3 part of strontium titanate particles A1, and mixing was conducted using a Henschel mixer at a peripheral speed of 30 m/sec for 180 seconds to give a toner for developing an electrostatic latent image. The properties of the resulting toner for developing an electrostatic latent image, the resulting image and so on were evaluated in the above manner. The results are shown in Table 2.

### Comparative Example 3

A four-neck flask equipped with a high-speed stirrer, i.e., TK homomixer (manufactured by TOKUSHU KIKA KOGYO CO., LTD.), was charged with 650 parts of ion exchange water and 500 parts of a 0.1 mol/L sodium triphosphate solution. The rotation number was set to 12000 rμm and the temperature was increased to 70° C. To the flask was gradually added 70 parts of a 1.0 mol/L calcium chloride aqueous solution to prepare aqueous dispersion medium containing fine, hardly water-soluble dispersion stabilizer calcium triphosphate colloid.

At the same time, 77 parts of styrene, 23 parts of 2-ethylhexyl acrylate, 0.2 part of divinylbenzene, 8 parts of carbon black, 6 parts of 1,1-bis(4-hydroxyphenyl)cyclohexane polycarbonate, 2 parts of negative charge control agent (azo dye iron compound) and 10 parts of a wax component were dispersed using an atriter (manufactured by Mitsui Mining and Smelting Co., Ltd.) for 3 hours, and thereto was then added 5 parts of 2,2′-azobis(2,4-dimethylvaleronitrile) to prepare a polymerizable monomer composition.

The polymerizable monomer composition was then introduced into the above-described aqueous dispersion medium containing dispersion stabilizer, and the mixture was stirred at an inner temperature of 70° C. under nitrogen atmosphere for 15 minutes with maintaining the rotation number of the high-speed stirrer at 12,000 rμm to form droplets of the polymerizable monomer composition. The stirrer was then replaced with a propeller stirring blade, and with stirring at 50 rμm, the system was kept at the same temperature for 10 hours to complete the polymerization. After completion of the polymerization, remaining monomers were removed under a heating and reduced pressure condition of 80° C./47 kPa (350 Torr), the suspension was cooled, and diluted hydrochloric acid was added thereto to remove the dispersion stabilizer. After repeating washing with water a few times, polymer particles were subjected to treatment for forming into spherical shape and drying for 6 hours using a conical ribbon drier (manufactured by OKAWARA MFG. CO., LTD.) with stirring by a spiral ribbon blade under a heating and reduced pressure condition of 45° C./1.3 kPa (10 Torr) for 6 hours, whereby toner particles was obtained.

100 parts of the obtained toner particles and 2 parts of oil-treated hydrophobic silica fine particles were dry-blended by a Henschel mixer to give a toner for developing an electrostatic latent image. The properties of the resulting toner for developing an electrostatic latent image, the resulting image and so on were evaluated in the above manner. The results are shown in Table 1.

TABLE 1

| | Ex. 1 | Ex. 2 |
|---|---|---|
| Properties of toner | | |
| Volume average particle | 7.7 | 7.5 |
| diameter (μm) | | |
| Particle diameter | 1.18 | 1.19 |
| distribution (Dv/Dp) | | |
| Volume mode diameter | 7.1 | 7.02 |
| (μm) | | |
| Standard deviation of | 1.58 | 1.41 |
| particle diameter | | |
| Average circle degree | 0.985 | 0.979 |
| Circle degree C1 | 0.988 | 0.981 |
| Circle degree C2 | 0.983 | 0.978 |
| C1/C2 | 1.005 | 1.003 |
| Conductivity | | |
| σ2 − σ1 | 4.6 | 4.2 |
| σ2 (μS/cm) | 4.9 | 4.5 |
| σ1 (μS/cm) | 0.3 | 0.3 |
| DSC curve | | |
| Melting peak | 64.9 | 54.7 |
| temperature | | |
| Enthalpy (mJ/mg) | 4.4 | 4.1 |
| Image properties | | |
| Fog | | |
| L/L | 10000 | 9000 |
| N/N | 10000 | 9500 |
| H/H | 10000 | 9000 |
| Reproducibility of thin | | |
| lines | | |
| L/L | 7000 | 7000 |
| N/N | 8000 | 8000 |
| H/H | 9000 | 9000 |
| Image density | | |
| initial printing | 1.68 | 1.66 |
| continuous | 1.62 | 1.62 |
| printing | | |

TABLE 2

| | Com. | Com. | Com. |
|---|---|---|---|
| | Ex. 1 | Ex. 2 | Ex. 3 |
| Properties of toner | | | |
| Volume average particle | 7.5 | 8.2 | 5.6 |
| diameter (μm) | | | |
| Particle diameter | 1.25 | 1.18 | 1.31 |
| distribution (Dv/Dp) | | | |
| Volume mode diameter | 7.02 | 7.9 | 5.7 |
| (μm) | | | |
| Standard deviation of | 1.74 | 1.54 | 2.05 |
| particle diameter | | | |
| Average circle degree | 0.965 | 0.975 | 0.984 |
| Circle degree C1 | 0.981 | 0.984 | 0.992 |
| Circle degree C2 | 0.961 | 0.969 | 0.971 |
| C1/C2 | 1.021 | 1.015 | 1.022 |
| Conductivity | | | |
| σ2 − σ1 | 10.5 | 21.8 | 23.8 |
| σ2 | 10.9 | 22.2 | 24.2 |
| (μS/cm) | | | |
| σ1 | 0.4 | 0.4 | 0.4 |
| (μS/cm) | | | |
| DSC curve | | | |
| Melting peak temperature | 72.4 | 76.3 | 75.2 |
| Enthalpy (mJ/mg) | 6.3 | 7.1 | 13.8 |
| Image properties | | | |
| Fog | | | |
| L/L | 8000 | 7500 | 7500 |
| N/N | 8500 | 7500 | 7000 |
| H/H | 8000 | 6500 | 5500 |
| Reproducibility of thin | | | |
| lines | | | |
| L/L | 6000 | 3500 | 3500 |
| N/N | 6500 | 4500 | 4000 |
| H/H | 8000 | 5000 | 5500 |
| Image density | | | |
| initial printing | 1.48 | 1.52 | 1.46 |
| continuous | 1.28 | 1.11 | 1.19 |
| printing | | | |

The results of evaluation of the toners for developing an electrostatic latent image in Tables 1 and 2 show the following facts:

The toner for developing an electrostatic latent image in Comparative Example 1, in which C1/C2 is larger than 1.02 and the σ2−σ1 value is larger than 10 μS/cm causes fog and has reduced reproducibility of fine lines and low printing density.

The toner for developing an electrostatic latent image of Comparative Example 2, in which σ2 is larger than 20 μS/cm and the σ2−σ1 value is larger than 10 μS/cm causes fog and has reduced reproducibility of fine lines and low printing density.

The toner for developing an electrostatic latent image of Comparative Example 3, in which (Dv/Dp) is larger than 1.3, C1/C2 is larger than 1.2, σ2 is larger than 20 μS/cm and σ2−σ1 value is larger than 10 μS/cm causes fog and has reduced reproducibility of fine lines and low printing density.

The toners for developing an electrostatic latent image of Examples 1 and 2 of the present invention have excellent reproducibility of fine lines, high image density and hardly suffer from fog.

### Example 3

900 parts of toluene, 78 parts of styrene, 19 parts of 2-ethylhexyl acrylate, 3 parts of 2-acrylamido-2-methylpropanesulfonic acid and 2 parts of azobisdimethylvaleronitrile was poured into a flask, and the mixture was allowed to react at 90° C. for 8 hours with stirring. After completion of the reaction, toluene was removed under reduced pressure to give a charge control resin A (weight average molecular weight Mw=21,000 as measured by gel permeation chromatography using tetrahydrofuran).

Monomers for a core composed of 5 parts of the above-mentioned charge control resin A, 90 parts of styrene, 9.3 parts of n-butylacrylate and 0.7 part of divinylbenzene, 5 parts of C.I. Pigment Blue 15:3 (manufactured by Clariant AG) as a cyan colorant, 0.8 part of a polymethacrylic ester macromonomer (manufactured by Toagosei Co., Ltd., trade name “AA6”, Tg=94° C.) and 10 parts of dipentaerythritolhexamyristate (melting point: 65° C., hydroxyl value: 0.16 mg KOH/g) were stirred until homogeneous using a usual stirrer to give a homogeneous mixture. 5 parts of t-butylperoxy-2-ethylhexanoate (trade name “Perbutyl 0”, manufactured by NOF Corporation) as a polymerization initiator was added to the homogeneous mixture to give a polymerizable monomer composition.

Separately, 4 parts of methyl methacrylate and 100 parts of water were mixed to obtain an aqueous dispersion of a polymerizable monomer for shell.

At the same time, an aqueous solution containing 5.9 parts of sodium hydroxide dissolved in 50 parts of ion-exchanged water was gradually added to an aqueous solution containing 9.5 parts of magnesium chloride dissolved in 250 parts of ion-exchanged water, with stirring, to prepare a magnesium hydroxide colloidal dispersion. The magnesium hydroxide colloidal dispersion was allowed to stand at 25° C. for 6 hours to be aged. The above-mentioned polymerizable monomer composition was poured into the aged dispersion, and the mixture was stirred at 15,000 rμm for 10 minutes by a continuous emulsifier/disperser, Ebara Milder MDN304 (manufactured by EBARA Corp.), thereby forming droplets of the polymerizable monomer composition (monomer composition for a core). To the obtained colloidal dispersion of magnesium hydroxide in which the droplets was contained was added 1 part of sodium tetraborate decahydrate, and the mixture was put in a reactor equipped with a stirring blade, and a polymerization reaction was started at 85° C. After the polymerization conversion reached about 100%, the aqueous dispersion of a polymerizable monomer for a shell and 0.3 part of 2,2′-azobis(2-methyl-N(2-hydroxyethyl)-propionamide (manufactured by Wako Pure Chemical Industries, Ltd., trade name “VA-086”) was poured into the reactor. After continuing the polymerization reaction for 4 hours, the reaction was terminated to give an aqueous dispersion of core-shell toner particles.

While stirring the aqueous dispersion of core-shell structure toner particles obtained above, the pH of the system was adjusted to 4 or lower, by adding sulfuric acid, for 10 minutes at 25° C. to refer as acid-washing. This dispersion was then dehydrated by filtration. Then, 500 parts of ion-exchanged water was added to form a slurry again and conduct washing with water at 38° C. Then, the dehydration and water washing procedure was repeated several times. Thereafter, solid content was separated by filtration and dried with a dryer for 2 days and nights at 45° C., whereby a toner particles was obtained.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a negatively charged toner for developing an electrostatic image. The thus obtained toner for developing the electrostatic image was evaluated in the above manner. The results are shown in Table.

### Example 4

0.134 part of potassium hydroxide and 2 parts of azobisvaleronitrile were added into 900 parts of toluene, 78 parts of styrene, 7 parts of 2-ethylhexyl acrylate, 9 parts of 2-acrylamido-2-methylpropanesulfonic acid and 2 parts of ethanol, and the mixture was allowed to react at 90° C. for 8 hours. The solvent was then removed under reduced pressure to give a charge control resin B (Mw=21,000). The acid value of the obtained charge control resin B was 6.7 mg KOH/g.

A toner for developing the electrostatic image was obtained in the same way as in Example 3, except that the charge control resin B was used. The properties of the resulting toner for developing the electrostatic image were evaluated in the above manner. The results are shown in Table 3.

### Comparative Example 4

Monomers for core composed of 80.5 parts of styrene and 19.5 parts of n-butylacrylate (Tg of a copolymer obtained by co-polymerizing these monomers=55° C.), 0.3 part of a polymethacrylic ester macromonomer (manufactured by Toagosei Co., Ltd., trade name “AA6”, Tg=94° C.), 0.5 part of divinylbenzene, 1.2 part of t-dodecyl mercaptane, 7 parts of C.I. Pigment Blue 15:3 (manufactured by Clariant AG), 5 parts of the charge control agent A and 2 parts of a parting agent (Fischer Tropsch wax, manufactured by NIPPON SEIRO CO., LTD, trade name “SP-3040”, endothermic peak: 100° C., melting point: 63° C., hydroxyl value: 0.1 mg KOH/g or less) were poured into a stirring container of a media-type wet grinder, thereby subjecting the parting agent to wet grinding, and 5 parts of t-butyl peroxy-2-ethylhexanoate (manufactured by NOF Corporation, trade name “Perbutyl 0”) was then added thereto to give a polymerizable monomer composition for core.

Separately, 2 parts of methyl methacrylate (Tg=105° C.) and 65 parts of water were mixed to obtain an aqueous dispersion of a polymerizable monomer for shell.

At the same time, an aqueous solution containing 6.2 parts of sodium hydroxide dissolved in 50 parts of ion-exchanged water was gradually added to an aqueous solution containing 10.2 parts of magnesium chloride dissolved in 250 parts of ion-exchanged water, with stirring, to prepare a magnesium hydroxide colloidal dispersion. 20 parts of an aqueous 5% sodium tetraborate decahydrate solution to obtain an aqueous dispersion of a dispersion stabilizer.

Immediately after preparing the aqueous dispersion of a dispersion stabilizer, thereto was pored into the above-described polymerizable monomer for core, and the mixture was passed through Ebara Milder (manufactured by Ebara Corporation, trade name MDN303V) rotating at 15,000 rμm in a total residence time of 3 seconds. The dispersion passed was circulated by returning it into the stirring bath via an inner nozzle at an ejection rate of 0.5 m/s to form droplets of the polymerizable monomer composition. The system was then heated to 90° C. to start a polymerization reaction. At the time the conversion of the monomer into a polymer reached about 100%, 0.3 part of 2-methyl-N-(2-hydroxyethyl)-propionamide (manufactured by Wako Pure Chemical Industries, Ltd., trade name: VA-086) was dissolved in the above aqueous dispersion of the polymerizable monomer for shell, and the mixture was poured into the reactor. After the polymerization reaction was continued for 4 hours, the reaction was stopped, to obtain an aqueous dispersion of toner particles. The aqueous dispersion of toner particles was subjected to acid washing, followed by dehydration and drying to obtain goner particles.

To 100 parts of the toner particles obtained above, there was added 0.6 part of colloidal silica (RX-100, manufactured by Nihon Aerosil Co. Ltd.) subjected to a hydrophobicity-imparting treatment.

They were mixed by means of a Henschel mixer to prepare a toner for developing an electrostatic image. The thus obtained toner for developing the electrostatic image was evaluated in the above manner. The results are shown in Table 4.

### Comparative Example 5

A four-neck flask was equipped with a reflux condenser, a water separator, a nitrogen gas inlet tube, a thermometer and a stirrer, and placed in a mantle heater. The flask was charged with a monomer composition containing 5 parts of bisphenol A-EO adduct, 5 parts of bisphenol A-PO adduct, 4 parts of terephthalic acid and 5 parts of fumaric acid, and with introducing nitrogen into the flask, the system was heated with stirring to carry out a reaction to give a polyester resin.

Subsequently, 70 parts of the polyester resin obtained as described above and 30 parts of C.I. Pigment Blue 15:3 (manufactured by Clariant AG) were charged into a pressure kneader and mixed. The obtained mixture was cooled and then pulverized by a feather mill to give a pigment masterbatch.

In the next place, 93 parts of the polyester resin, 10 parts of the pigment masterbatch, which were obtained as described above, 2 parts of zinc salicylate metal complex (manufactured by Orient Chemical Industries, Ltd., trade name “E84”) and 2 parts of oxidized low molecular weight polypropylene (manufactured by Sanyo Chemical Industries, Ltd., tradename “Viscol TS200”, melting point: 140° C., hydroxyl value: 3.3 mg KOH/g) were sufficiently mixed by a Henschel mixer. The mixture was then melt-kneaded by a twin-screw extrusion kneader, and the resulting kneaded product was rapidly cooled and coarsely pulverized by a feather mill. The coarsely pulverized product was subjected to coarse particle classification by a jet mill (manufactured by Nippon Pneumatic Mfg. Co., Ltd., trade name “IDS”), and then fine particle classification by a DS classifier (manufactured by Nippon Pneumatic Mfg. Co., Ltd.) to give toner base particles.

To 100 parts of the obtained toner base particles were added 0.5 part of hydrophobic silica TS500 (manufactured by Cabosil Co. Ltd., BET specific surface area: 225 m²/g) and 0.3 part by weight of hydrophobic silica NAX50 (Nippon Aerosil Co., Ltd., BET specific surface area: 40 m²/g), and mixing was conducted using a Henschel mixer at a peripheral speed of 30 m/sec for 90 seconds.

Subsequently, using a surface modification apparatus (Surfusing system, manufactured by Nippon Pneumatic Mfg. Co., Ltd.), surface modification of the toner base particles was carried out under conditions of highest temperature: 250° C., residence time: 0.5 second, powder dispersion density: 100 g/m³, cooling air temperature: 18° C. and cooling water temperature: 10° C. To 100 parts of the toner base particles were added 0.5 part of hydrophobic silica R972 (manufactured by Nippon Aerosil Co., Ltd., BET specific surface area 110 m²/g) and 0.3 part of strontium titanate particles A1, and mixing was conducted using a Henschel mixer at a peripheral speed of 30 m/sec for 180 seconds to give a toner for developing an electrostatic latent image. The thus obtained toner for developing the electrostatic image was evaluated in the above manner. The results are shown in Table 4.

### Comparative Example 6

10 parts by weight of calcium phosphate was finely dispersed in 500 parts of water, and the temperature of the mixture was increased to 65° C. to obtain an aqueous dispersion.

In addition, 90 parts of styrene, 9 parts of 2-ethylhexylacrylate, 1 part of methylmethacrylate, 5 parts of a colorant (C.I. pigment blue 15:3), 0.5 part of di-t-butyl-salicylic metal compound, 5 parts of a polyester resin, 10 parts of an ester wax (melting point: 60° C., hydroxyl value: 1.2 mg KOH/g, weight average molecular weight: 3,500) and 0.05 part of divinyl benzene were mixed, heated to 65° C. and sufficiently dissolved and dispersed to give a polymerizable monomer composition.

The above-described aqueous dispersion was stirred under high shearing force using a high-speed rotation shear stirrer, Clearmix (manufactured by M TECHNIQUE Co., Ltd.), and the polymerizable monomer composition prepared above was introduced thereinto and formation of droplets were carried out for 10 minutes. Thereto was added 4 parts of 2,2′-azobis(2,4-dimethylvaleronitrile) and formation of droplets were carried out for additional 5 minutes. After completion of the formation of droplets, the aqueous dispersion medium containing droplets was transferred to a container of a stirrer equipped with MAX BLEND blade (manufactured by Sumitomo Heavy Industries, Ltd.) and the rotation number was adjusted to 60 rotations/minute. The polymerization was continued at an internal temperature of 65° C. When the conversion reached 90%, 1 part of benzoyl peroxide was added thereto over 60 seconds.

The polymerization temperature was increased to 75° C. and stirring under heating was continued for 5 hours to complete the polymerization. After completion of the polymerization reaction, the remaining monomers were removed under reduced pressure, and after cooling, diluted hydrochloric acid was added thereto to dissolve the dispersant, and solid-liquid separation, water washing, filtration and drying were conducted to give toner particles.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a negatively charged toner for developing an electrostatic image. The thus obtained toner for developing the electrostatic image was evaluated in the above manner. The results are shown in Table 4.

TABLE 3

| | Ex. 3 | Ex. 4 |
|---|---|---|
| Properties of toner | | |
| Volume average | 6.7 | 6.6 |
| particle diameter | | |
| (μm) | | |
| Particle diameter | 1.2 | 1.19 |
| distribution | | |
| (Dv/Dp) | | |
| Volume mode | 7.1 | 7.02 |
| diameter (μm) | | |
| Standard deviation | 0.17 | 0.17 |
| of particle | | |
| diameter | | |
| Average circle | 0.98 | 0.965 |
| degree | | |
| Circle degree C1 | 0.983 | 0.981 |
| Circle degree C2 | 0.975 | 0.971 |
| C1/C2 | 1.008 | 1.010 |
| Content of an | 4.6 | 6 |
| n-hexane extract | | |
| component | | |
| (% by weight) | | |
| Content of a | 3.3 | 3.7 |
| methanol extract | | |
| component | | |
| (% by weight) | | |
| Weight average | 2275 | 2275 |
| molecular weight of | | |
| parting agent | | |
| Image properties | | |
| Shelf stability | 1.0 | 1.2 |
| Flowability | 96.0 | 93.0 |
| Fog | | |
| L/L | 10,000 | 9,000 |
| N/N | 10,000 | 9,000 |
| H/H | 8,000 | 7,000 |
| Reproducibility of | | |
| fine lines | | |
| L/L | 9,000 | 8,500 |
| N/N | 7,500 | 7,500 |
| H/H | 7,000 | 7,000 |
| Image density | | |
| initial | 1.67 | 1.58 |
| printing | | |
| continuous | 1.6 | 1.56 |
| printing | | |
| Fixing temperature | 120 | 120 |
| Offset temperature | 200 | 200 |

TABLE 4

| | Com. | Com. | Com. |
|---|---|---|---|
| | Ex. 4 | Ex. 5 | Ex. 6 |
| Properties of | | | |
| toner | | | |
| Volume average | 6.5 | 6.6 | 6.7 |
| particle diameter | | | |
| (μm) | | | |
| Particle diameter | 1.19 | 1.19 | 1.25 |
| distribution | | | |
| (Dv/Dp) | | | |
| Volume mode | 7.02 | 7.02 | 6.51 |
| diameter (μm) | | | |
| Standard deviation | 0.27 | 0.18 | 0.22 |
| of particle | | | |
| diameter | | | |
| Average circle | 0.975 | 0.979 | 0.980 |
| degree | | | |
| Circle degree C1 | 0.98 | 0.981 | 0.992 |
| Circle degree C2 | 0.957 | 0.972 | 0.967 |
| C1/C2 | 1.025 | 1.009 | 1.026 |
| Content of an | 3.8 | 10 | 16 |
| n-hexane extract | | | |
| component | | | |
| (% by weight) | | | |
| Content of a | 6.6 | 9.3 | 9.1 |
| methanol extract | | | |
| component | | | |
| (% by weight) | | | |
| Weight average | 425 | 3500 | 3500 |
| molecular weight | | | |
| of parting agent | | | |
| Image properties | | | |
| Shelf stability | 3.2 | 13.2 | 19 |
| Flowability | 73.8 | 78.0 | 58.0 |
| Fog | | | |
| L/L | 7,000 | 8,000 | 7,000 |
| N/N | 6,500 | 7,000 | 6,500 |
| H/H | 6,000 | 6,500 | 6,000 |
| Reproducibility of | | | |
| fine lines | | | |
| L/L | 6,500 | 5,500 | 6,000 |
| N/N | 6,000 | 3,500 | 5,000 |
| H/H | 5,000 | 4,000 | 4,500 |
| Image density | | | |
| initial printing | 1.60 | 1.65 | 1.66 |
| continuous | 1.36 | 1.2 | 1.28 |
| printing | | | |
| Fixing temperature | 120 | 110 | 130 |
| Offset temperature | 200 | 180 | 160 |

The results of evaluation of the toners for developing an electrostatic latent image in Tables 3 and 4 show the following facts:

The toner for developing an electrostatic latent image in Comparative Example 4, in which C1/C2 is larger than 1.02 and the content of a methanol extract component is larger than 5% by weight has reduced shelf stability and flowability, easily causes fog, and has reduced reproducibility of fine lines and reduced printing density in the continuous printing.

The toner for developing an electrostatic latent image of Comparative Example 5, in which the content of a methanol extract component is larger than 5% by weight has reduced shelf stability and flowability, easily causes fog, and has reduced reproducibility of fine lines and reduced printing density in the continuous printing.

The toner for developing an electrostatic latent image of Comparative Example 6, in which C1/C2 is larger than 1.02, the content of a n-hexane extract component is larger than 15% by weight and the content of a methanol extract component is larger than 5% by weight has reduced shelf stability and flowability, easily causes fog, and has reduced reproducibility of fine lines and reduced printing density in the continuous printing.

On the contrary, the toners for developing an electrostatic latent image of Examples 3 and 4 of the present invention have excellent shelf stability, flowability and reproducibility of fine lines, has high printing density and is free of occurrence of fog.

### INDUSTRIAL APPLICABILITY

According to the present invention, a toner for developing an electrostatic latent image, which is less likely to cause fog and excellent in dot reproducibility and printing characteristics is provided.

1-9. (canceled)

10. A toner for developing an electrostatic latent image, comprising a toner particles containing at least a binder resin, a colorant and a charge control agent,
the toner particles having
a volume mode diameter (a) from 5 to 10 μm,
a ratio (Dv/Dp), of a volume average particle diameter (Dv) to a number average particle diameter (Dp), from 1.0 to 1.3,
and an average circle degree from 0.97 to 0.995,
the toner particles having a standard deviation (b) not more than 2 μm of the particle diameter of not more than 2 μm,
the toner particles having a ratio (C1/C2) from 1.00 to 1.02, wherein C1 represents an average circle degree of the toner particles having a particle diameter not less than (a−2b) μm to less than a μm, and C2 represents an average circle degree of the toner particles having a particle diameter of not less than a μm to less than (a+2b) μm,
the toner having a content of a n-hexane extract component in the range from 1 to 15% by weight and a content of a methanol extract component of 5% by weight or less.

11. The toner for developing the electrostatic latent image according to claim 10, further comprising a parting agent.

12. The toner for developing the electrostatic latent image according to claim 11, wherein the parting agent has a weight average molecular weight in the range from 1,000 to 3,000.

13. The toner for developing the electrostatic latent image according to claim 11, wherein the parting agent has a melting point in the range from 40 to 100° C.

14. The toner for developing the electrostatic latent image according to claim 11, wherein the parting agent has a hydroxyl value in the range from 0 to 5 mg KOH/g.

15. The toner for developing the electrostatic latent image according to claim 10, wherein the charge control agent is a charge control resin having a weight average molecular weight in the range from 3,000 to 300,000.

16. The toner for developing the electrostatic latent image according to claim 10, wherein (C1/C2) is in the range from 1.00 to 1.01.

17. The toner for developing the electrostatic latent image according to claim 10, wherein (C1/C2) is in the range from 1.00 to 1.005.

18. (canceled)
